(19) United States
(12) Patent Application Publication
(10) Pub. No.: US 2025/0189873 A1
(43) Pub. Date: Jun. 12, 2025

(54) CAMERA MODULE

(71) Applicant: Sharp Sensing Technology Corporation, Tenri City (JP)

(72) Inventors: Haruno YOSHIDA, Tenri City (JP); Yoshihito ISHIZUE, Tenri City (JP); Sae MANO, Tenri City (JP); Fumio TORIMATSU, Tenri City (JP)

(21) Appl. No.: 18/973,390

(22) Filed: Dec. 9, 2024

(30) Foreign Application Priority Data
Dec. 12, 2023 (JP) 2023-209724

(51) Int. Cl. G03B 17/17; G02B 7/04; G03B 17/12

(52) U.S. Cl. CPC G03B 17/17; G02B 7/04; G03B 17/12

(57) ABSTRACT

A camera module comprises a reflecting element configured to reflect first light incident along a first optical axis and to discharge second light along a second optical axis; driven body including a lens group disposed on the second optical axis; a housing including: a first housing section having a first hollow space housing the reflecting element; a second housing section having a second hollow space housing the driven body, the second hollow space having an opening that is open in a perpendicular direction that is perpendicular to the second optical axis; and a drive unit having a hole; a holder including: a first portion housed in the second hollow space to hold the driven body; and a second portion inserted in the hole to be driven by the drive unit; and a cover configured to cover the opening.

### CROSS-REFERENCE TO RELATED APPLICATION

The present application claims priority from Japanese Application JP2023-209724, the content of which is hereby incorporated by reference into this application.

### BACKGROUND OF THE INVENTION

### 1. Field of the Invention

The present disclosure relates to camera modules.

### 2. Description of the Related Art

U.S. Pat. No. 1,037,1928 discloses a folded camera module. The folded camera module includes a reflecting member, a lens actuation sub-assembly, and an image sensor that are all disposed along an optical axis direction. The lens actuation sub-assembly is interposed between the reflecting member and the image sensor. In the lens actuation sub-assembly, a lens barrel houses the lens element. The lens actuation sub-assembly is moved in the Y-Z plane by a voice coil motor provided on one surface thereof (see col. 6, line 62 to col. 7, line 48).

### SUMMARY OF THE INVENTION

In the folded camera module disclosed in Patent Literature 1, the reflecting member, the lens actuation sub-assembly, and the image sensor are disposed along an optical axis direction, and the lens actuation sub-assembly is interposed between the reflecting member and the image sensor. Therefore, if the lens actuation sub-assembly is attempted to be attached from the optical axis direction, the lens actuation sub-assembly interferes with the reflecting member, a structure for holding a reflecting element, an image sensor, or a structure for holding the image sensor. Therefore, the lens actuation sub-assembly is attached from a direction perpendicular to the optical axis direction.

However, the attaching of the lens actuation sub-assembly from a direction perpendicular to the optical axis direction renders it difficult to dispose the voice coil motor on the four surfaces of the lens actuation sub-assembly. The voice coil motor is indeed provided only on one surface of the lens actuation sub-assembly in the folded camera module disclosed in Patent Literature 1. Therefore, it is difficult to drive the lens actuation sub-assembly in a stable manner, which leads to insufficient thrust for driving the lens actuation sub-assembly.

The present disclosure, in an aspect thereof, has been made in view of these problems. The present disclosure, in an aspect thereof, has an object to provide, for example, a camera module that is easy to assemble, capable of driving a lens group in a stable manner, and also capable of generating a large thrust.

The present disclosure, in an aspect thereof, is directed to a camera module including: a reflecting element configured to reflect first light incident along a first optical axis and to discharge second light along a second optical axis; a driven body including a lens group disposed on the second optical axis; a housing including: a first housing section having a first hollow space housing the reflecting element; a second housing section having a second hollow space housing the driven body, the second hollow space having an opening that is open in a perpendicular direction that is perpendicular to the second optical axis; and a drive unit having a hole; a holder including: a first portion housed in the second hollow space to hold the driven body; and a second portion inserted in the hole to be driven by the drive unit; and a cover configured to cover the opening.

### BRIEF DESCRIPTION OF THE DRAWINGS

FIG. 1 is a schematic perspective view of a camera module in accordance with Embodiment 1.

FIG. 2 is a schematic exploded perspective view of the camera module in accordance with Embodiment 1.

FIG. 3 is a schematic vertical cross-sectional view of a vertical cross-section of the camera module in accordance with Embodiment 1.

FIG. 4 is a schematic perspective view of a holder in the camera module in accordance with Embodiment 1.

FIG. 5 is a schematic horizontal cross-sectional view of a horizontal cross-section of the camera module in accordance with Embodiment 1, taken at a Z-direction position at which there is provided a second housing section.

FIG. 6 is a schematic horizontal cross-sectional view of a horizontal cross-section of the camera module in accordance with Embodiment 1, taken at the Z-direction position at which there is provided a drive unit.

FIG. 7 is a schematic horizontal cross-sectional view of a horizontal cross-section of the camera module in accordance with Embodiment 1, taken at the Z-direction position at which there is provided a third housing section.

FIG. 8 is a schematic vertical cross-sectional view of a vertical cross-section of a housing in a camera module in accordance with Embodiment 2.

FIG. 9 is a schematic perspective view of a main body in a camera module in accordance with Embodiment 3.

FIG. 10 is a schematic vertical cross-sectional view of a vertical cross-section of the main body in the camera module in accordance with Embodiment 3.

FIG. 11 is a schematic exploded perspective view of a camera module in accordance with Embodiment 4.

FIG. 12 is a schematic vertical cross-sectional view of a vertical cross-section of the camera module in accordance with Embodiment 4.

FIG. 13 is a schematic perspective view of a holder in the camera module in accordance with Embodiment 4.

FIG. 14 is a schematic perspective view of a main body in a camera module in accordance with Embodiment 5.

FIG. 15 is a schematic vertical cross-sectional view of a vertical cross-section of the main body in the camera module in accordance with Embodiment 5.

FIG. 16 is a schematic exploded perspective view of a holder and a driven body in the camera module in accordance with Embodiment 5.

FIG. 17 is a schematic vertical cross-sectional view of a vertical cross-section of a lens holder and a lens group in a camera module in accordance with Embodiment 6.

FIG. 18 is a schematic perspective view of the lens holder and the lens group in the camera module in accordance with Embodiment 6 as they are dissected in a vertical cross-section thereof.

### DETAILED DESCRIPTION OF THE INVENTION

The following will describe embodiments of the present disclosure with reference to drawings. Identical and equivalent elements in the drawings are denoted by the same reference numerals, and description thereof is not repeated.

### 1 Embodiment 1

### 1.1 Camera Module

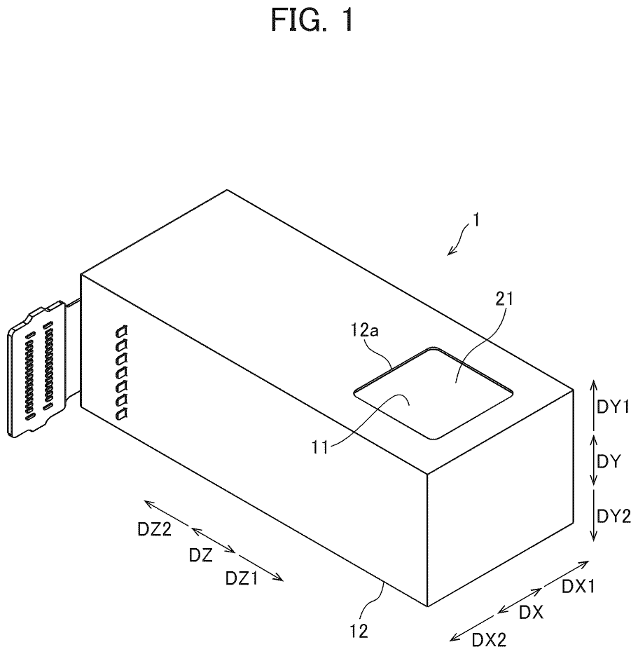

FIG. 1 is a schematic perspective view of a camera module in accordance with

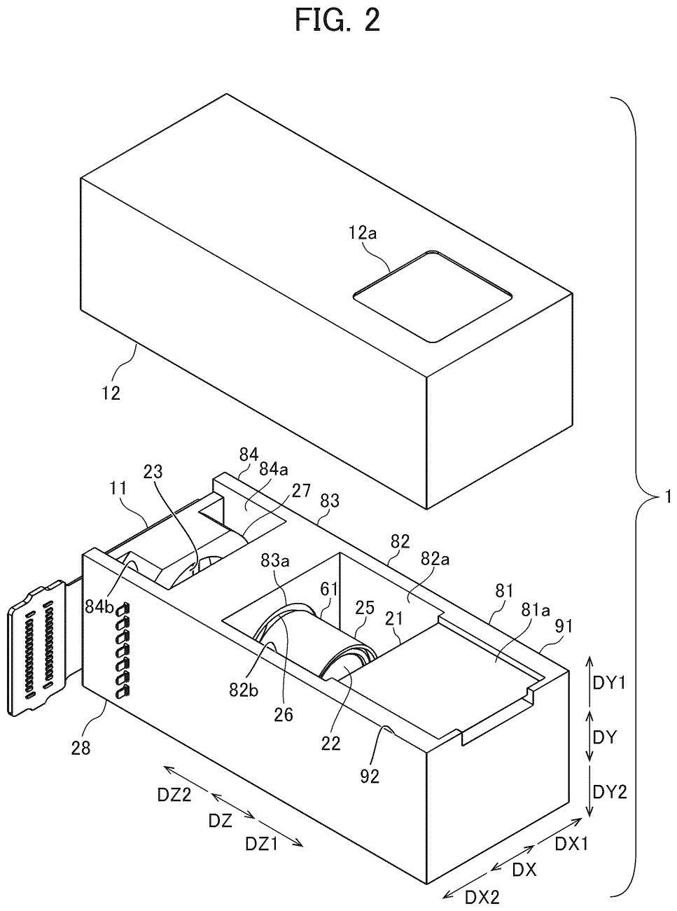

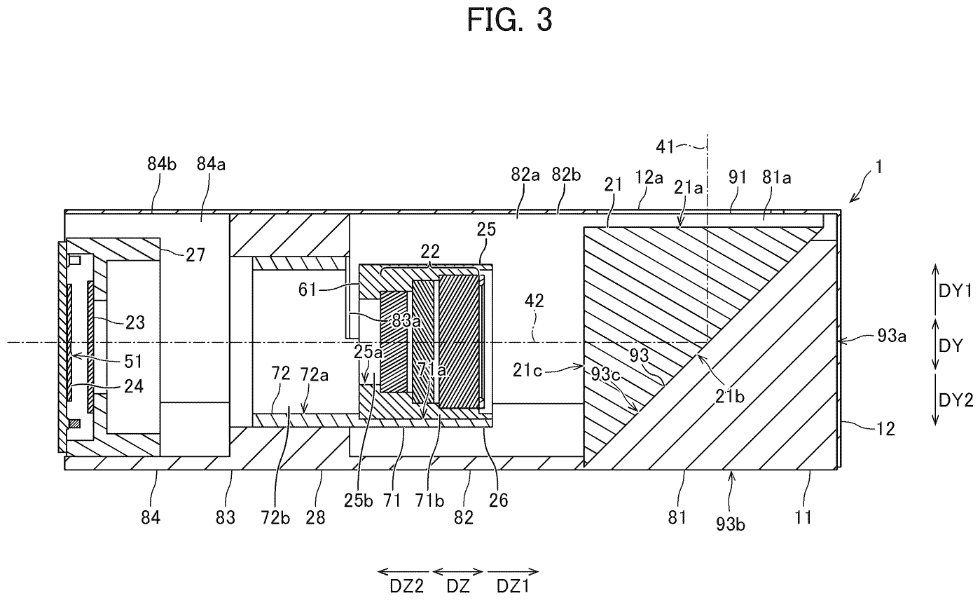

Embodiment 1. FIG. 2 is a schematic exploded perspective view of the camera module in accordance with Embodiment 1. FIG. 3 is a schematic vertical cross-sectional view of a vertical cross-section of the camera module in accordance with Embodiment 1.

A camera module 1 in accordance with Embodiment 1 shown in FIGS. 1 to 3 causes incident object light to form an object image and captures the object image thus formed, to output an image signal in accordance with the object image.

The camera module 1 is a telecamera module including an image-capturing optical system with a long focal length.

The camera module 1 is incorporated into a smartphone. The camera module 1 may be incorporated in a device other than a smartphone.

Referring to FIGS. 1 to 3, the camera module 1 includes a main body 11 and a cover 12. The main body 11 includes a reflecting element 21, a lens group 22, an infrared cutoff filter 23, an image sensor 24, a lens barrel 25, a holder 26, an image sensor holder 27, and a housing 28.

The reflecting element 21 and the lens group 22 form a folded optical system that has a first optical axis 41 and a second optical axis 42 and that bends the optical path of object light that comes from an object. The second optical axis 42 is perpendicular to the first optical axis 41. The second optical axis 42 may not be perpendicular to the first optical axis 41.

Here, X-directions DX are defined as directions perpendicular to the first optical axis 41 and to the second optical axis 42, Y-directions DY are defined as directions parallel to the first optical axis 41 and perpendicular to the second optical axis 42, and Z-directions DZ are defined as directions perpendicular to the first optical axis 41 and parallel to the second optical axis 42. In addition, a +X-direction DX1 is defined as one of the X-directions DX, a −X-direction DX2 is defined as the other one of the X-directions DX, a +Y-direction DY1 is defined as one of the Y-directions DY, a −Y-direction DY2 is defined as the other one of the Y-directions DY, a +Z-direction DZ1 is defined as one of the Z-directions DZ, and a −Z-direction DZ2 is defined as the other one of the Z-directions DZ.

### 1.2 Reflecting Element

The reflecting element 21 reflects first light incident along the first optical axis 41 and discharges second light along the second optical axis 42.

The reflecting element 21 is a prism. The reflecting element 21 may be a reflecting element other than a prism. For example, the reflecting element 21 may be a mirror.

The reflecting element 21 is a right angle prism. Therefore, the reflecting element 21 has an entrance face 21a, a reflection face 21b, and an exit face 21c. The entrance face 21a intersects with the first optical axis 41 and is perpendicular to the Y-directions DY. The reflection face 21b intersects with the first optical axis 41 and the second optical axis 42 and makes an angle of 45° with the Y-directions DY and the Z-directions DZ. The exit face 21c intersects with the second optical axis 42 and is perpendicular to the Z-directions DZ.

The first light, traveling along the first optical axis 41, is incident on the entrance face 21a of the reflecting element 21. The first light, traveling along the first optical axis 41, is incident on the reflection face 21b of the reflecting element 21. The reflection face 21b reflects the incident, first light to generate the second light. The reflection face 21b discharges the second light traveling along the second optical axis 42. The reflecting element 21 discharges, through the exit face 21c thereof, the second light traveling along the second optical axis 42.

### 1.3 Lens Group

The lens group 22 is disposed on the second optical axis 42. The lens group 22 is disposed between the reflecting element 21 and the image sensor 24.

The lens group 22 transmits the second light to converge the second light on an image-forming face 51. Hence, the lens group 22 causes the second light to form an object image. The object image is formed on the image-forming face 51. The lens group 22 forms an image-capturing optical system for causing the second light to form an object image.

The lens group 22 contains one or more lenses.

The image-capturing optical system may include a lens group of two or more lenses.

### 1.4 Infrared Cutoff Filter

The infrared cutoff filter 23 is disposed on the second optical axis 42. The infrared cutoff filter 23 is disposed between the lens group 22 and the image sensor 24.

The infrared cutoff filter 23 transmits the second light and cuts infrared light components off the second light.

### 1.5 Image Sensor

The image sensor 24 is disposed on the second optical axis 42.

The image sensor 24 photoelectrically converts the second light converged by the image-forming face 51 to electric signals. Hence, the image sensor 24 captures the object image formed on the image-forming face 51 and outputs an image signal in accordance with the object image.

The outputted image signal is subjected to, for example, software processing. Hence, final image data is obtained from the image signal.

The image sensor 24 is, for example, a complementary metal oxide semiconductor (CMOS) image sensor or a charge coupled device (CCD) image sensor.

### 1.6 Lens Barrel

The lens barrel 25 is shaped like a hollow cylinder. Therefore, the lens barrel 25 has an inner circumferential surface 25a. The lens barrel 25 contains formed therein a hollow space 25b delineated by the inner circumferential surface 25a.

The hollow space 25b in the lens barrel 25 houses the lens group 22. The inner circumferential surface 25a of the lens barrel 25 holds the outer circumferences of the lenses in the housed lens group 22. Hence, the lens barrel 25 holds the housed lens group 22.

### 1.7 Driven Body

The lens group 22 and the lens barrel 25 move like a single member. Therefore, the lens group 22 and the lens barrel 25 form a driven body 61 that is driven like a single member.

### 1.8 Holder

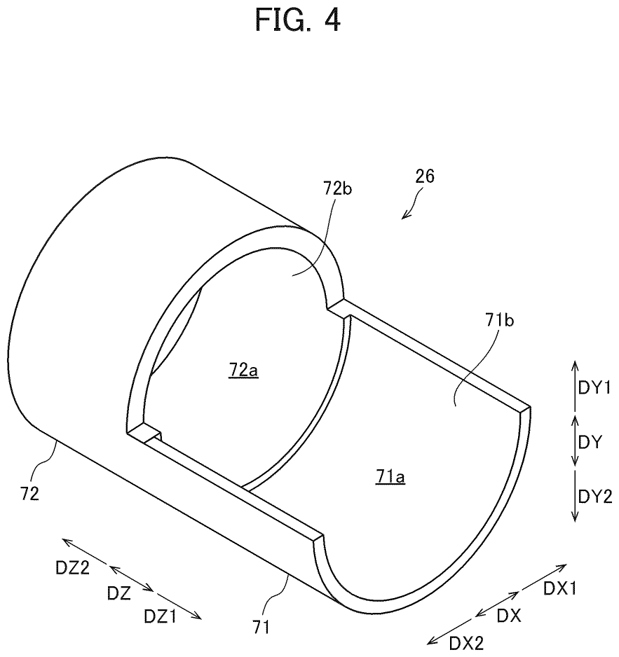

FIG. 4 is a schematic perspective view of a holder in the camera module in accordance with Embodiment 1.

Referring to FIGS. 3 and 4, the holder 26 includes a first portion 71 and a second portion 72.

The first portion 71 is shaped like a hollow hemicylinder. Therefore, the first portion 71 has an inner circumferential surface 71a. The first portion 71 contains formed therein a hollow space 71b delineated by the inner circumferential surface 71a. The hollow space 71b is shaped like a hemicylinder.

The hollow space 71b in the first portion 71 houses one half of the driven body 61.

The first portion 71 has a cylindrical axis that matches the second optical axis 42. Therefore, the second light travels along the cylindrical axis of the first portion 71.

The inner circumferential surface 71a of the first portion 71 provides a mounting surface on which the driven body 61 is mounted. The driven body 61 is attached to the inner circumferential surface 71a. Hence, the first portion 71 holds the driven body 61.

The inner circumferential surface 71a of the first portion 71 is exposed in the +Y-direction DY1. Therefore, the driven body 61 is mounted on the inner circumferential surface 71a by moving the driven body 61 in the −Y-direction DY2 so that the driven body 61 bumps onto the inner circumferential surface 71a.

The first portion 71 has an inner diameter that fits to the outer diameter of the lens barrel 25. This particular structure restrains a non-uniform gap from forming between the lens barrel 25 and the first portion 71.

The second portion 72 is shaped like a hollow cylinder. Therefore, the second portion 72 has an inner circumferential surface 72a. The second portion 72 contains formed therein a hollow space 72b delineated by the inner circumferential surface 72a. The hollow space 72b is shaped like a cylinder.

The second portion 72 has a cylindrical axis that matches the second optical axis 42. Therefore, the second light travels through the hollow space 72b in the second portion 72 along the cylindrical axis of the second portion 72.

The first portion 71 and the second portion 72 have the same outer diameter. The end portion of the first portion 71 toward the −Z-direction DZ2 and the end portion of the second portion 72 toward the +Z-direction DZ1 are connected to each other. The first portion 71 is disposed in the +Z-direction DZ1 of the second portion 72.

### 1.9 Image Sensor Holder

The image sensor holder 27 holds the infrared cutoff filter 23 and the image sensor 24.

### 1.10 Housing

Referring to FIGS. 2 and 3, the housing 28 includes a first housing section 81, a second housing section 82, a drive unit 83, and a third housing section 84.

The first housing section 81, the second housing section 82, the drive unit 83, and the third housing section 84 form an integral member. Therefore, the drive unit 83 is a part of the housing 28.

Referring to FIGS. 2 and 3, the first housing section 81 includes a wall 91, a wall 92, and a base 93.

The wall 91 and the wall 92 are located away from the second optical axis 42 in the +X-direction DX1 and the −X-direction DX2 respectively and is perpendicular to the X-directions DX.

The base 93 is disposed between the wall 91 and the wall 92.

The base 93 is shaped like a right-angle triangular prism. Therefore, the base 93 has a side face 93a, a side face 93b, and a side face 93c. The side face 93a is perpendicular to the Z-directions DZ. The side face 93b is perpendicular to the Y-directions DY. The side face 93c makes an angle of 45° with the Y-directions DY and the Z-directions DZ.

The first housing section 81 contains formed therein a first hollow space 81a delineated by the wall 91, the wall 92, and the base 93. The first hollow space 81a houses the reflecting element 21.

The side face 93c of the base 93 is in face-to-face contact with the reflection face 21b of the reflecting element 21. Hence, the side face 93c of the base 93 supports the reflecting element 21.

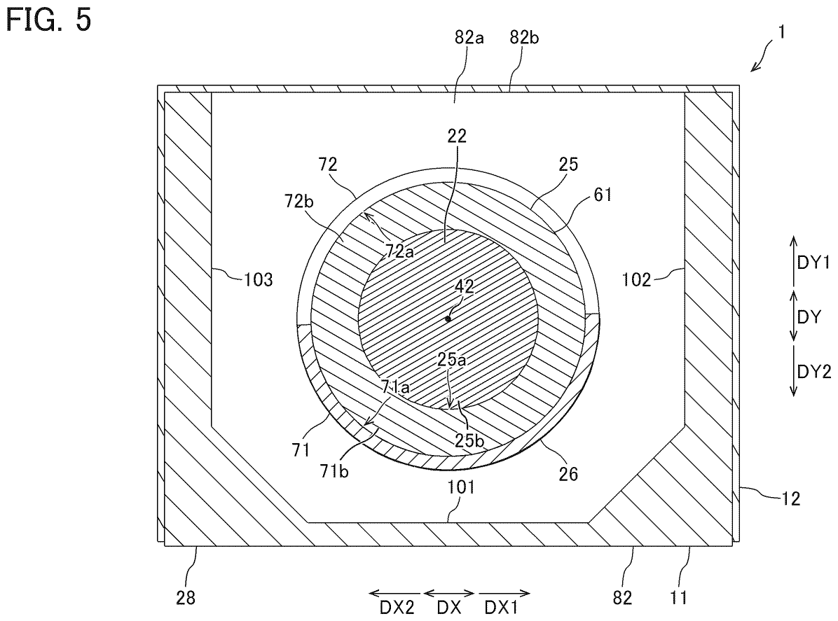

FIG. 5 is a schematic horizontal cross-sectional view of a horizontal cross-section of the camera module in accordance with Embodiment 1, taken at a Z-direction position at which there is provided a second housing section.

Referring to FIG. 5, the second housing section 82 includes a first wall 101, a second wall 102, and a third wall 103.

The first wall 101, the second wall 102, and the third wall 103 are located away from the second optical axis 42 in the −Y-direction DY2, the +X-direction DX1, and the −X-direction DX2 respectively. By being located away from the second optical axis 42 in the −Y-direction DY2, the +X-direction DX1, and the −X-direction DX2, which are the three directions of a first direction, a second direction, and a third direction, respectively, the first wall 101, the second wall 102, and the third wall 103 form a groove-like structure. Therefore, the second housing section 82 contains formed therein a second hollow space 82a delineated by the first wall 101, the second wall 102, and the third wall 103. The second hollow space 82a houses the driven body 61 and the first portion 71.

The second hollow space 82a in the second housing section 82 has a first opening 82b that is open in the +Y-direction DY1 where none of the first wall 101, the second wall 102, and the third wall 103 is present. The second hollow space 82a having the first opening 82b located away from the second optical axis 42 in the +Y-direction DY1, which is a fourth direction, enables the driven body 61 to pass through the first opening 82b when the driven body 61 is moved in the −Y-direction DY2 to bump onto the inner circumferential surface 71a of the first portion 71.

The second housing section 82 is disposed in the +Z-direction DZ1 of the drive unit 83.

### 1.11 Drive Unit

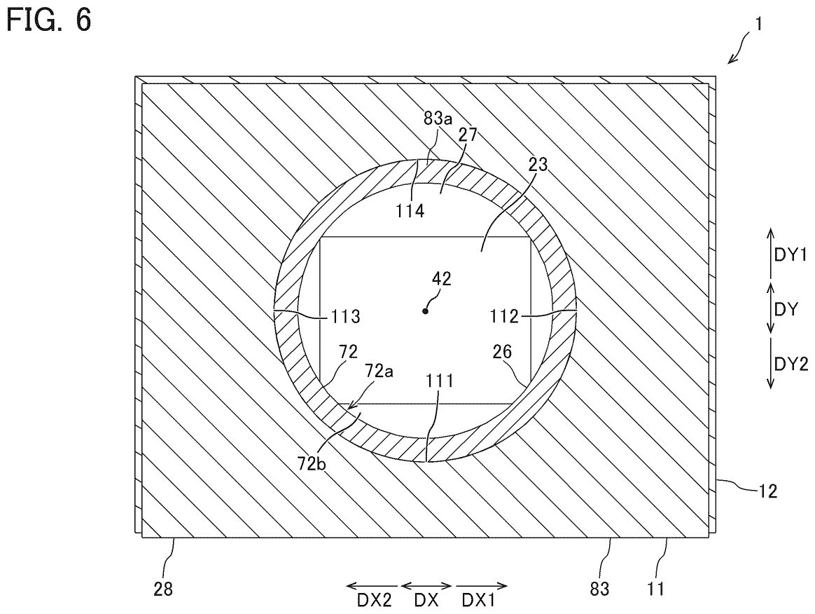

FIG. 6 is a schematic horizontal cross-sectional view of a horizontal cross-section of the camera module in accordance with Embodiment 1, taken at the Z-direction position at which there is provided a drive unit.

Referring to FIG. 6, the drive unit 83 includes a fourth wall 111, a fifth wall 112, a sixth wall 113, and a seventh wall 114.

The fourth wall 111, the fifth wall 112, the sixth wall 113, and the seventh wall 114 are located away from the second optical axis 42 in the −Y-direction DY2, the +X-direction DX1, the −X-direction DX2, and the +Y-direction DY1 respectively. By being located away from the second optical axis 42 in the −Y-direction DY2, the +X-direction DX1, the −X-direction DX2, and the +Y-direction DY1, which are the four directions of the first direction, the second direction, the third direction, and the fourth direction, respectively, the fourth wall 111, the fifth wall 112, the sixth wall 113, and the seventh wall 114 form a tubular structure. Therefore, the drive unit 83 has formed therein a hole 83a delineated by the fourth wall 111, the fifth wall 112, the sixth wall 113, and the seventh wall 114. The hole 83a extends in the Z-directions DZ. The second portion 72 is inserted in the hole 83a. The drive unit 83 holds the inserted second portion 72.

Referring to FIG. 3, the first portion 71 has a length, in the Z-directions DZ, that is close to the length of the hole 83a of the drive unit 83. Therefore, the holder 26, including the first portion 71 and the second portion 72, has a length, in the Z-directions DZ, that is longer than the length of the hole 83a approximately by as much as the second portion 72. Therefore, the holder 26 sticks out on one end thereof in the Z-directions DZ from the hole 83a. The second portion 72 is housed in the hole 83a. The first portion 71, disposed in the +Z-direction DZ1 of the second portion 72, is housed in the second hollow space 82a in the second housing section 82, the second hollow space 82a being disposed in the +Z-direction DZ1 of the hole 83a.

The drive unit 83 drives the second portion 72 in the Z-directions DZ. Hence, the drive unit 83 drives the first portion 71 and the driven body 61, which move like a single member together with the second portion 72, in the Z-directions DZ. By the drive unit 83 driving the driven body 61 including the lens group 22 in the Z-directions DZ in this manner, focusing becomes possible by a all groups feeding system.

In addition, the drive unit 83 drives the second portion 72 in the X-directions DX and the Y-directions DY. Hence, the drive unit 83 drives the first portion 71 and the driven body 61, which move like a single member together with the second portion 72, in the X-directions DX and the Y-directions DY. By the drive unit 83 driving the driven body 61 including the lens group 22 the X-directions DX and the Y-directions DY in this manner, optical image stabilization becomes possible. Instead of causing the drive unit 83 to drive the second portion 72 in the X-directions DX and the Y-directions DY, the drive mechanism for driving the reflecting element 21 may be caused to rotate the reflecting element 21 around a rotation axis that is parallel to the X-directions DX and around a rotation axis that is parallel to the Y-directions DY. Alternatively, the drive unit 83 may be caused to drive the second portion 72 in the Y-directions DY, and the drive mechanism for driving the reflecting element 21 may be caused to rotate the reflecting element 21 around a rotation axis that is parallel to the X-directions DX. As another alternative, the drive unit 83 may be caused to drive the second portion 72 in the X-directions DX, and the drive mechanism for driving the reflecting element 21 may be caused to rotate the reflecting element 21 around a rotation axis that is parallel to the Y-directions DY.

The drive unit 83 includes, for example, a voice coil motor (VCM). The coil, the magnet, and the yoke, among others, in the VCM are built inside the fourth wall 111, the fifth wall 112, the sixth wall 113, and the seventh wall 114.

In many wide-angle camera modules, a drive unit surrounds the hole to which the lens group is inserted from four directions perpendicular to the optical axis. Therefore, the drive unit is capable of driving the lens group in a stable manner and exerting a large thrust. It should be understood however that when the hole is surrounded from four directions perpendicular to the optical axis, it is difficult to insert the lens group to the hole from a direction perpendicular to the optical axis. Therefore, the lens group is inserted in the hole from a direction parallel to the optical axis.

In many telecamera modules with folded optical systems, the hole to which the lens group is inserted is sandwiched between either a reflecting element or an element holding the reflecting element and either an image sensor or an element holding the image sensor in a direction parallel to the optical axis. Therefore, it is difficult to insert the lens group to the hole from a direction parallel to the optical axis. In addition, if the lens group is attempted to be inserted into the hole from a direction parallel to the optical axis, the precision of positioning the lens group falls due to the difficulty in inserting the lens group. Therefore, the lens group needs to be inserted into the hole from a direction perpendicular to the optical axis. Therefore, it is impossible to surround the hole with the drive unit from four directions perpendicular to the optical axis. Therefore, the drive unit is not capable of driving the lens group in a stable manner and exerting a large thrust.

In the camera module 1 in accordance with Embodiment 1, the drive unit 83 surrounds the hole 83a from four directions perpendicular to the second optical axis 42 to address these problems. However, the lens group 22 is not inserted in the hole 83a, but the second portion 72, which moves like a single member together with the lens group 22, is provided in the hole 83a.

In addition, the first portion 71 holding the lens group 22 is disposed in the second hollow space 82a in the second housing section 82, the second hollow space 82a being visible through the first opening 82b of the second housing section 82 from the +Y-direction DY1 perpendicular to the second optical axis 42. Hence, the drive unit 83 is capable of driving the lens group 22 in a stable manner and exerting a large thrust. In addition, the lens group 22 can be inserted into the second hollow space 82a from the +Y-direction DY1. Therefore, the camera module 1 can be easily assembled.

### 1.12 Third Housing Section

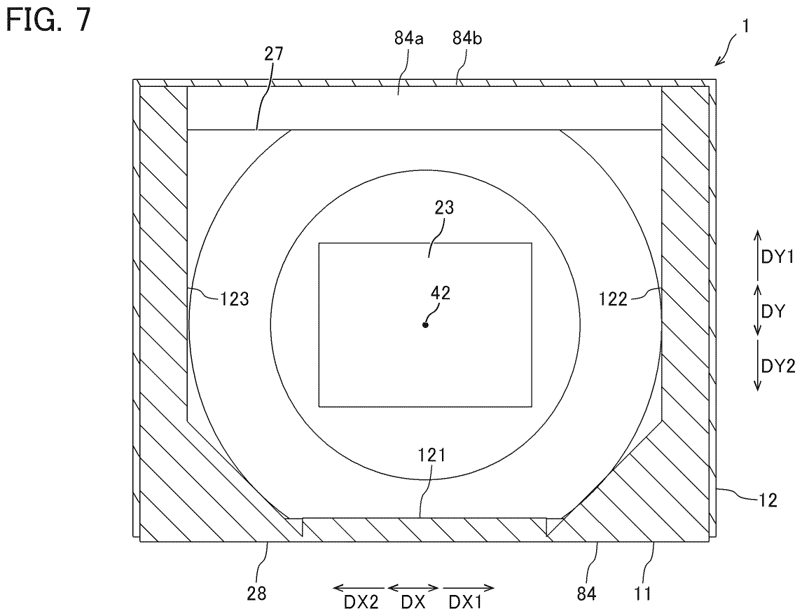

FIG. 7 is a schematic horizontal cross-sectional view of a horizontal cross-section of the camera module in accordance with Embodiment 1, taken at the Z-direction position at which there is provided a third housing section.

Referring to FIG. 7, the third housing section 84 includes a wall 121, a wall 122, and a wall 123.

The wall 121, the wall 122, and the wall 123 are located away from the second optical axis 42 in the −Y-direction DY2, the +X-direction DX1, and the −X-direction DX2 respectively. By being located away from the second optical axis 42 in the −Y-direction DY2, the +X-direction DX1, and the −X-direction DX2, which are the three directions of the first direction, the second direction, and the third direction, respectively, the wall 121, the wall 122, and the wall 123 form a groove-like structure. Therefore, the third housing section 84 contains formed therein a third hollow space 84a delineated by the wall 121, the wall 122, and the wall 123. The image sensor holder 27 is disposed in the third hollow space 84a.

The third hollow space 84a in the third housing section 84 has a second opening 84b that is open in the +Y-direction DY1 where none of the wall 121, the wall 122, and the wall 123 is present.

The third housing section 84 is disposed in the −Z-direction DZ2 of the drive unit 83.

### 1.13 Walls of Housing

The housing 28 has an external shape like a quadrangular prism and is shaped like a bathtub. The first wall 101 of the second housing section 82, the fourth wall 111 of the drive unit 83, and the wall 121 of the third housing section 84 form a bottom wall of the housing 28. The second wall 102 of the second housing section 82, the fifth wall 112 of the drive unit 83, and the wall 122 of the third housing section 84 form one of sidewalls of the housing 28. The third wall 103 of the second housing section 82, the sixth wall 113 of the drive unit 83, and the wall 123 of the third housing section 84 form the other sidewall of the housing 28. An opening that is open in the +Y-direction DY1 is formed between the end portion of one of the sidewalls of the housing 28 located in the +Y-direction DY1 and the end portion of the other sidewall of the housing 28 located in the +Y-direction DY1.

### 1.14 Cover

Referring to FIGS. 1 to 3 and FIGS. 5 to 7, the cover 12 is attached to the main body 11 to cover the main body 11. Hence, the cover 12 covers the first opening 82b of the second housing section 82 and the second opening 84b of the third housing section 84.

The cover 12 is removed from the main body 11 when the lens group 22 is attached to the first portion 71. The cover 12 is attached to the main body 11 after the lens group 22 is attached to the first portion 71.

The cover 12 has formed thereto a window 12a that intersects with the first optical axis 41. The window 12a transmits the first light traveling along the first optical axis 41. Hence, the camera module 1 can take in object light.

### 2 Embodiment 2

The following description will focus on differences between Embodiment 2 and Embodiment 1. The description may be silent about the structures and features of Embodiment 2 that are the same as those of Embodiment 1.

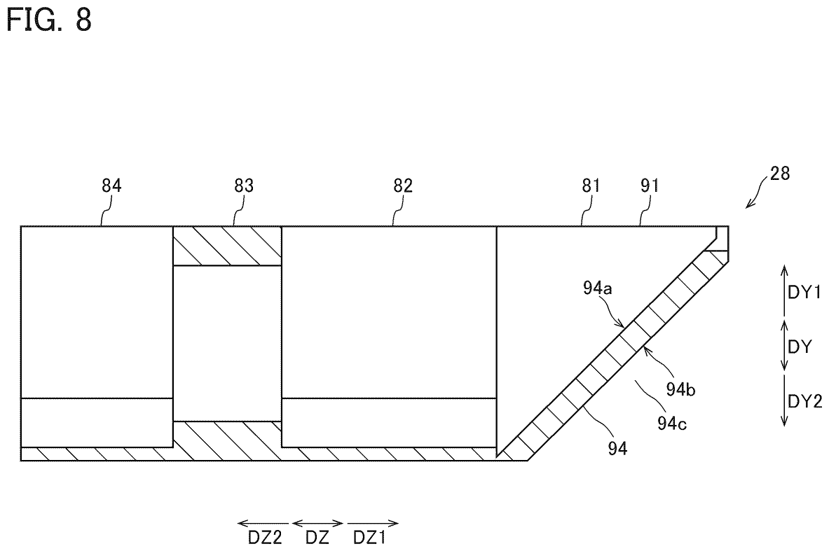

FIG. 8 is a schematic vertical cross-sectional view of a vertical cross-section of a housing in a camera module in accordance with Embodiment 2.

In Embodiment 2, as shown in FIG. 8, the first housing section 81 includes a support plate 94 in place of the base 93.

The support plate 94 has a first main face 94a and a second main face 94b. The first main face 94a and the second main face 94b are located on mutually opposite sides.

The first main face 94a of the support plate 94 faces an intermediate direction between the +Y-direction DY1 perpendicular to the second optical axis 42 and the −Z-direction DZ2 parallel to the second optical axis 42 and running from the reflecting element 21 toward the lens group 22. The first main face 94a is in face-to-face contact with the reflection face 21b of the reflecting element 21. Hence, the first main face 94a supports the reflecting element 21.

The second main face 94b of the support plate 94 faces a hollow space 94c.

In Embodiment 2, the main body 11 includes no drive mechanism for driving the reflecting element 21. Therefore, the hollow space 94c can house, for example, high-profile connectors and circuit components. Hence, the camera module 1 can be reduced in size. The connectors and circuit components, among others, housed in the hollow space 94c form, for example, an interface for connecting the camera module 1 to another component.

### 3 Embodiment 3

The following description will focus on differences between Embodiment 3 and Embodiment 1. The description may be silent about the structures and features of Embodiment 3 that are the same as those of Embodiment 1.

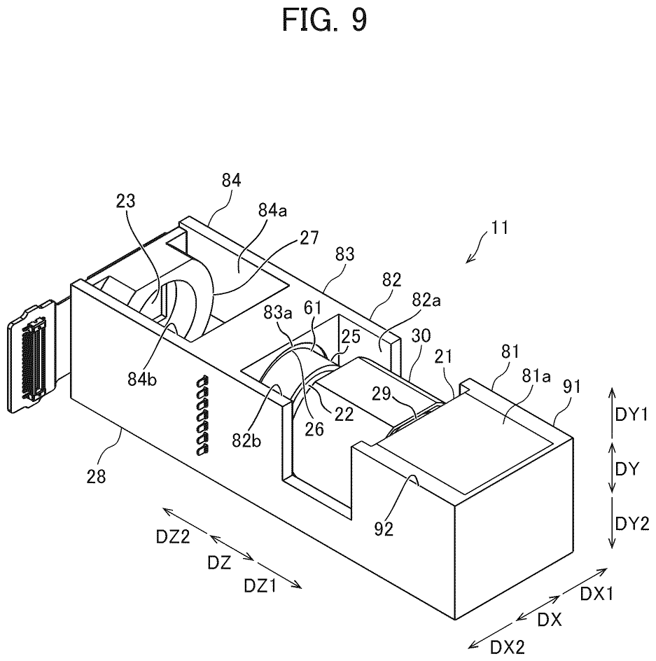

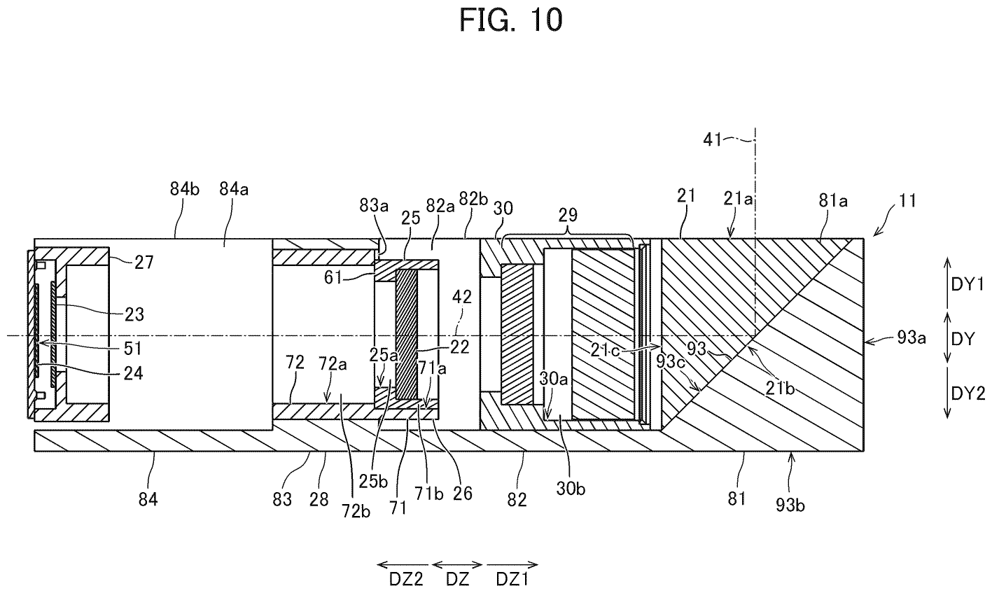

FIG. 9 is a schematic perspective view of a main body in a camera module in accordance with Embodiment 3. FIG. 10 is a schematic vertical cross-sectional view of a vertical cross-section of the main body in the camera module in accordance with Embodiment 3.

In Embodiment 3, as shown in FIGS. 9 and 10, the main body 11 includes a fixed lens group 29 and a fixed lens barrel 30.

The fixed lens group 29 is disposed in the second hollow space 82a in the second housing section 82. The fixed lens group 29 is disposed between the reflecting element 21 and the lens group 22.

The fixed lens group 29 includes two or more lenses. The fixed lens group 29, as a whole, has positive power. The fixed lens group 29 transmits the second light to direct the second light to the lens group 22.

The lens group 22 includes one or more lenses. The lens group 22, as a whole, has negative power. The lens group 22 is disposed in a succeeding stage of the fixed lens group 29. The lens group 22 transmits the second light that has transmitted through the fixed lens group 29 to converge the second light onto the image-forming face 51. Hence, the lens group 22 causes the second light to form an object image. The object image is formed on the image-forming face 51.

The fixed lens group 29 and the lens group 22 form an image-capturing optical system for causing the second light to form an object image.

The fixed lens barrel 30 is shaped like a hollow cylinder. Therefore, the fixed lens barrel 30 has an inner circumferential surface 30a. The fixed lens barrel 30 includes formed therein a hollow space 30b delineated by the inner circumferential surface 30a.

The hollow space 30b in the fixed lens barrel 30 houses the fixed lens group 29. The inner circumferential surface 30a of the fixed lens barrel 30 holds the outer circumferences of the lenses in the housed fixed lens group 29. Hence, the fixed lens barrel 30 can hold the housed fixed lens group 29.

The fixed lens barrel 30 is disposed in the second hollow space 82a in the second housing section 82. The fixed lens barrel 30 is attached to the second housing section 82. Hence, the fixed lens group 29 is fixed to the housing 28 via the fixed lens barrel 30.

The drive unit 83 is capable of focusing by an inner focus scheme. Hence, the stroke of the lens group 22 required for focusing can be reduced in length. Hence, the camera module 1 can be reduced in size.

### 4 Embodiment 4

The following description will focus on differences between Embodiment 4 and Embodiment 1. The description may be silent about the structures and features of Embodiment 4 that are the same as those of Embodiment 1.

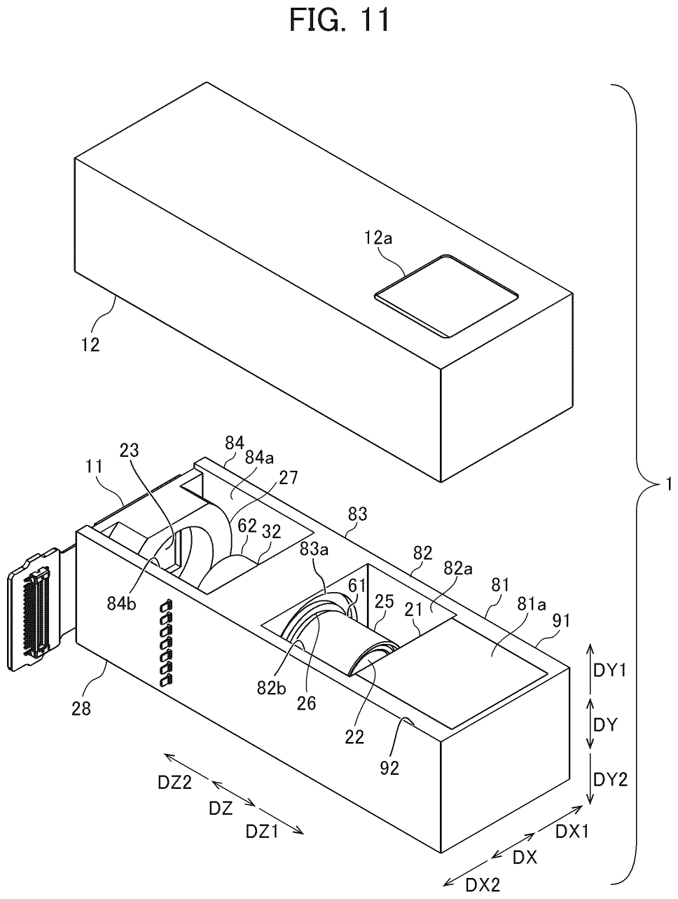

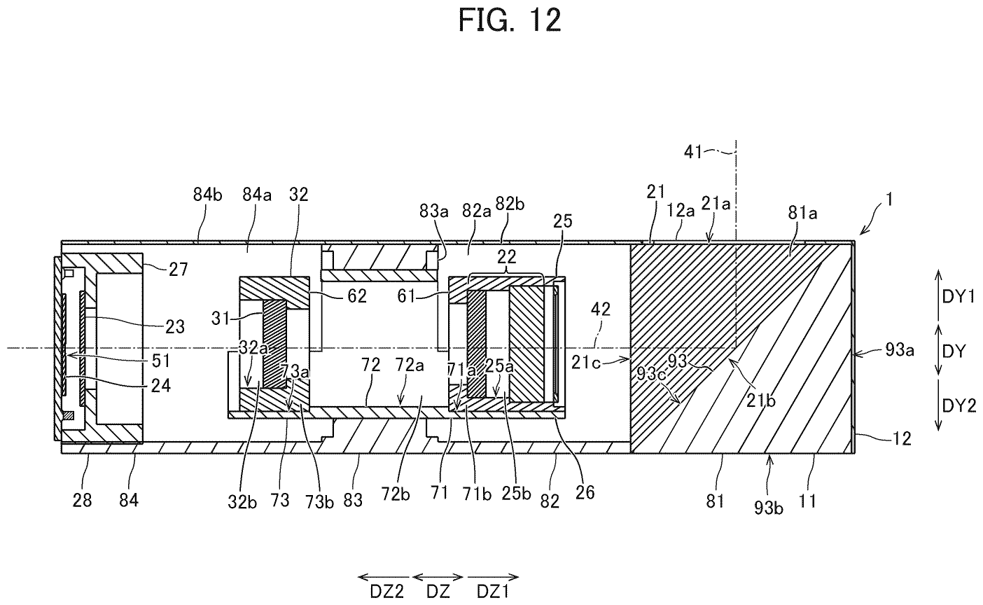

FIG. 11 is a schematic exploded perspective view of a camera module in accordance with Embodiment 4. FIG. 12 is a schematic vertical cross-sectional view of a vertical cross-section of the camera module in accordance with Embodiment 4.

In Embodiment 4, as shown in FIGS. 11 and 12, the main body 11 includes a lens group 31 and a lens barrel 32.

The lens group 31 is a second lens group when the lens group 22 is a first lens group. The lens barrel 32 is a second lens barrel when the lens barrel 25 is a first lens barrel.

The lens group 22 includes two or more lenses. The lens group 22, as a whole, has positive power. The lens group 22 transmits the second light to direct the second light to the lens group 31.

The lens group 31 is disposed on the second optical axis 42. The lens group 31 is disposed in a succeeding stage of the lens group 22. The lens group 31 is disposed between the lens group 22 and the image sensor 24.

The lens group 31 includes one or more lenses. The lens group 31, as a whole, has negative power. The lens group 31 transmits the second light that has transmitted through the lens group 22 to converge the second light onto the image-forming face 51. Hence, the lens group 22 causes the second light to form an object image. The object image is formed on the image-forming face 51.

The lens group 22 and the lens group 31 form an image-capturing optical system for causing the second light to form an object image.

The lens barrel 32 is shaped like a hollow cylinder. Therefore, the lens barrel 32 has an inner circumferential surface 32a. The lens barrel 32 contains formed therein a hollow space 32b delineated by the inner circumferential surface 32a.

The hollow space 32b in the lens barrel 32 houses the lens group 31. The inner circumferential surface 32a of the lens barrel 32 holds the outer circumferences of the lenses in the housed lens group 31. Hence, the lens barrel 32 holds the housed lens group 31.

The lens group 31 and the lens barrel 32 move like a single member. Therefore, the lens group 31 and the lens barrel 32 form a driven body 62 driven like a single member. The driven body 62 is housed in the third hollow space 84a in the third housing section 84.

The driven body 62 is a second driven body when the driven body 61 is a first driven body.

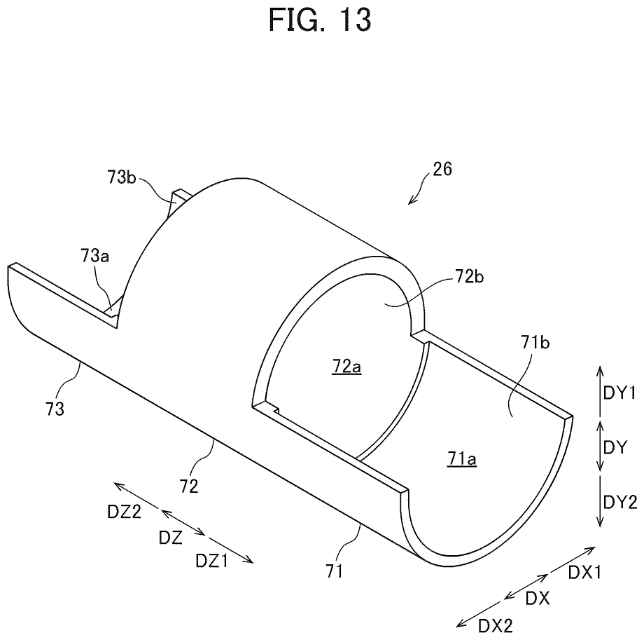

FIG. 13 is a schematic perspective view of a holder in the camera module in accordance with Embodiment 4.

Referring to FIGS. 12 and 13, the holder 26 includes a third portion 73.

The third portion 73 is shaped like a hollow hemicylinder. Therefore, the third portion 73 has an inner circumferential surface 73a. The third portion 73 contains formed therein a hollow space 73b delineated by the inner circumferential surface 73a. The hollow space 73b is shaped like a hemicylinder.

The hollow space 73b in the third portion 73 houses one half of the driven body 62.

The third portion 73 has a cylindrical axis that matches with the second optical axis 42. Therefore, the second light travels along the cylindrical axis of the third portion 73.

The inner circumferential surface 73a of the third portion 73 provides a mounting surface on which the driven body 62 is mounted. The driven body 62 is attached to the inner circumferential surface 73a. Hence, the third portion 73 holds the driven body 62.

The inner circumferential surface 73a of the third portion 73 is exposed in the +Y-direction DY1. Therefore, the driven body 62 is mounted to the inner circumferential surface 73a of the third portion 73 by moving the driven body 62 in the −Y-direction DY2 so that the driven body 62 bumps onto the inner circumferential surface 73a of the third portion 73.

The third portion 73 has an inner diameter that fits to the outer diameter of the lens barrel 32. This particular structure restrains a non-uniform gap from forming between the lens barrel 32 and the third portion 73.

The third portion 73 and the second portion 72 have the same outer diameter. The end portion of the third portion 73 toward the +Z-direction DZ1 and the end portion of the second portion 72 toward the −Z-direction DZ2 are connected to each other. The first portion 71 and the third portion 73 are disposed in the +Z-direction DZ1 and the −Z-direction DZ2 of the second portion 72 respectively. Therefore, the holder 26 sticks out on both sides thereof in the Z-directions DZ from the hole 83a of the drive unit 83.

The third portion 73 is disposed in the third hollow space 84a in the third housing section 84.

In the camera module 1 in accordance with Embodiment 4, the drive unit 83 surrounds the hole 83a of the drive unit 83 from four directions perpendicular to the second optical axis 42. However, the lens group 22 and the lens group 31 are not inserted in the hole 83a of the drive unit 83, but the second portion 72, which moves like a single member together with the lens group 22 and the lens group 31, is inserted in the hole 83a. In addition, the first portion 71 holding the lens group 22 is disposed in the second hollow space 82a in the second housing section 82, the second hollow space 82a being visible through the first opening 82b of the second housing section 82 from the +Y-direction DY1 perpendicular to the second optical axis 42. In addition, the third portion 73 holding the lens group 31 is disposed in the third hollow space 84a in the third housing section 84, the third hollow space 84a being visible through the second opening 84b of the third housing section 84 from the +Y-direction DY1 perpendicular to the second optical axis 42. Hence, the drive unit 83 is capable of driving the lens group 22 and the lens group 31 in a stable manner and exerting a large thrust. In addition, the lens group 22 can be inserted into the second hollow space 82a in the second housing section 82 from a direction perpendicular to the second optical axis 42. In addition, the lens group 31 can be inserted into the third hollow space 84a in the third housing section 84 from a direction perpendicular to the second optical axis 42. Therefore, the camera module 1 can be easily assembled.

### 5 Embodiment 5

The following description will focus on differences between Embodiment 5 and Embodiment 1. The description may be silent about the structures and features of Embodiment 5 that are the same as those of Embodiment 1.

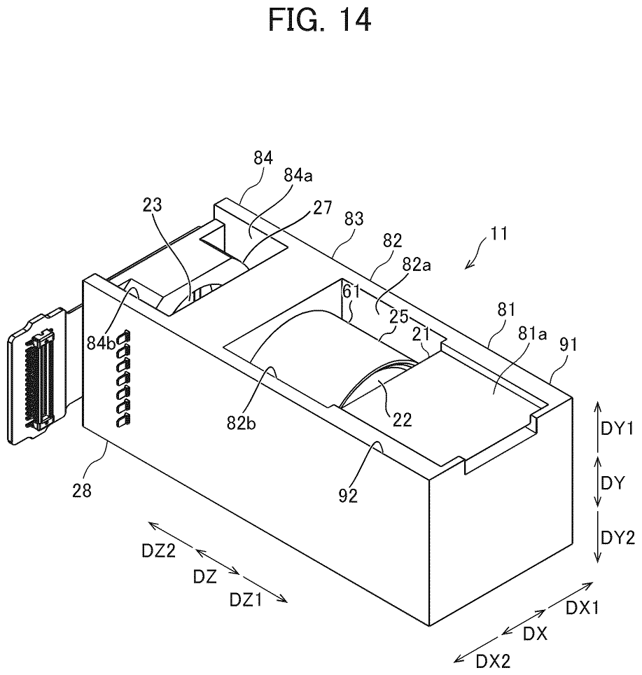

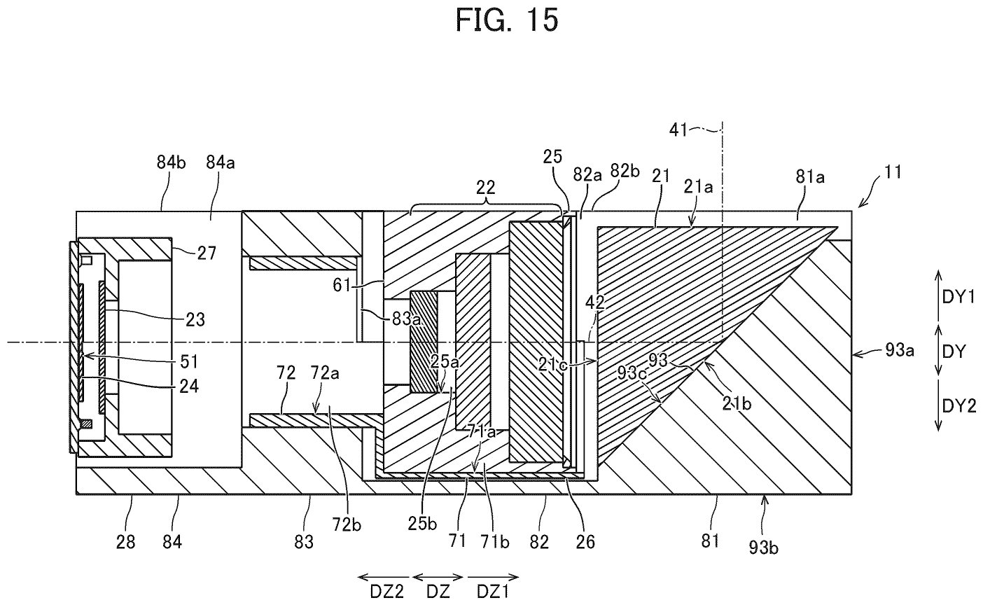

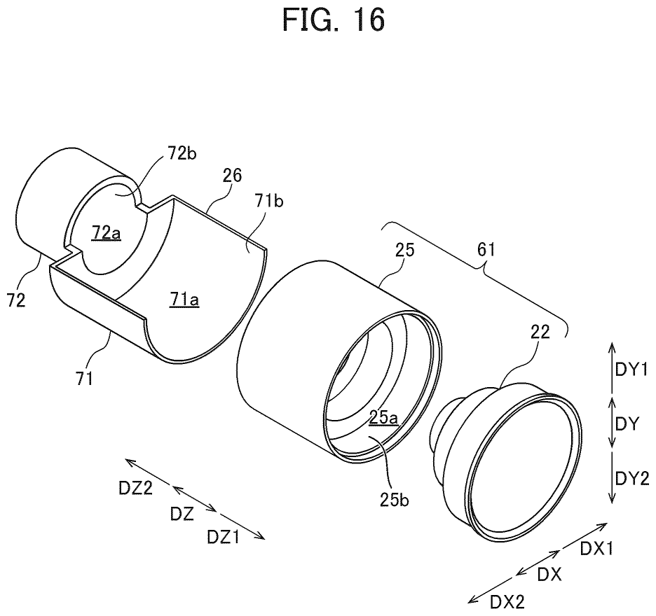

FIG. 14 is a schematic perspective view of a main body in a camera module in accordance with Embodiment 5. FIG. 15 is a schematic vertical cross-sectional view of a vertical cross-section of the main body in the camera module in accordance with Embodiment 5. FIG. 16 is a schematic exploded perspective view of a holder and a driven body in the camera module in accordance with Embodiment 5.

In Embodiment 5, as shown in FIGS. 14 to 16, the first portion 71 has an inner diameter that is larger than the outer diameter of the second portion 72. Hence, the outer diameter of the driven body 61 held by the first portion 71 can be increased. Hence, the outer diameter of the lens group 22, which is a part of the driven body 61, can be increased over the outer diameter of the second portion 72.

### 6 Embodiment 6

The following description will focus on differences between Embodiment 6 and Embodiment 1. The description may be silent about the structures and features of Embodiment 6 that are the same as those of Embodiment 1.

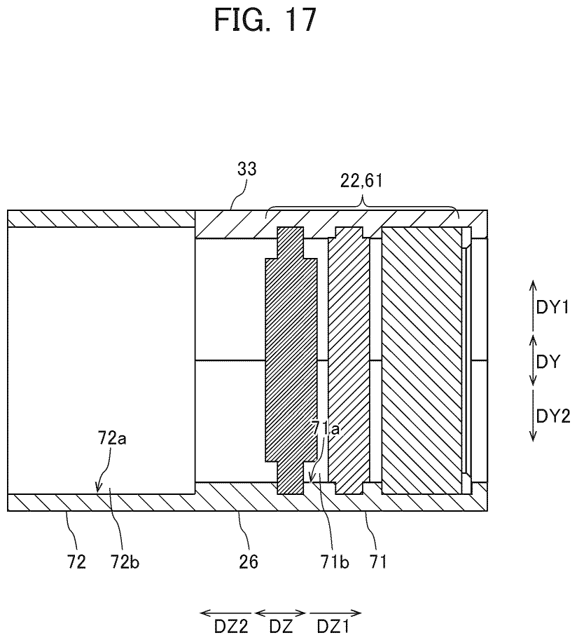

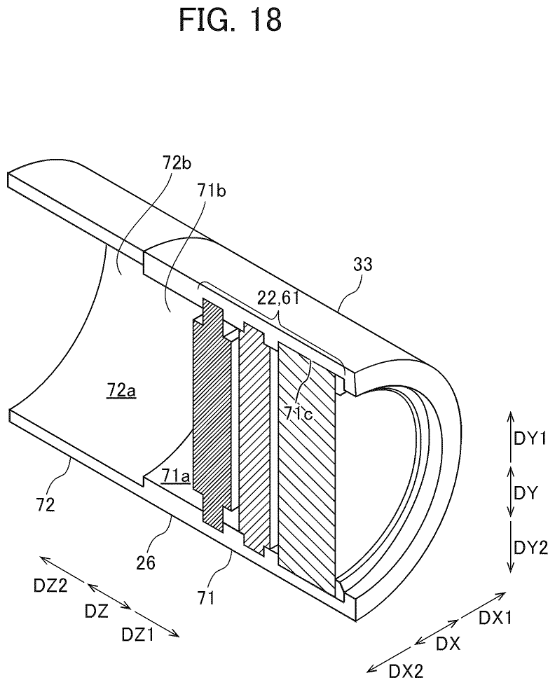

FIG. 17 is a schematic vertical cross-sectional view of a vertical cross-section of a lens holder and a lens group in a camera module in accordance with Embodiment 6. FIG. 18 is a schematic perspective view of the lens holder and the lens group in the camera module in accordance with Embodiment 6 as they are dissected in a vertical cross-section thereof.

In Embodiment 6, as shown in FIGS. 17 and 18, the main body 11 includes no lens barrel 25. Therefore, the first portion 71 directly holds the lens group 22. Hence, the outer diameter of the first portion 71 can be reduced by as much as the thickness of the lens barrel 25. Hence, the camera module 1 can be reduced in size.

The inner circumferential surface 71a of the first portion 71 has formed thereon a groove 71c in which the outer circumferential edges of the lenses in the lens group 22 is housed.

Referring to FIGS. 17 and 18, the main body 11 includes a lens cover 33.

The lens cover 33 is shaped like a hollow hemicylinder. The lens cover 33 is located opposite the first portion 71 with the lens group 22 intervening therebetween. The first portion 71 and the lens cover 33 form a structure shaped like a hollow cylinder and surround the lens group 22. Hence, the light incident to the lens group 22 from the +Y-direction DY1 can be restrained from producing, for example, flares and ghosts.

The present disclosure is not limited to the description of the embodiments and examples above. Any structure detailed in the embodiments and examples may be replaced by a practically identical structure, a structure that delivers practically the same effect and function, or a structure that achieves practically the same purpose.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A camera module comprising:
a reflecting element configured to reflect first light incident along a first optical axis and to discharge second light along a second optical axis;
a driven body including a lens group disposed on the second optical axis;
a housing including:
a first housing section having a first hollow space housing the reflecting element;
a second housing section having a second hollow space housing the driven body, the second hollow space having an opening that is open in a perpendicular direction that is perpendicular to the second optical axis; and
a drive unit having a hole;
a holder including:
a first portion housed in the second hollow space to hold the driven body; and
a second portion inserted in the hole to be driven by the drive unit; and
a cover configured to cover the opening.

2. The camera module according to claim 1, wherein the first portion has a mounting surface on which the driven body is mounted.

3. The camera module according to claim 1, wherein the first portion is shaped like a hollow hemicylinder.

4. The camera module according to claim 1, wherein
the second housing section is disposed in one of parallel directions of the drive unit, the parallel directions being parallel to the second optical axis, and
the first portion is disposed in that parallel direction of the second portion.

5. The camera module according to claim 4, wherein
the lens group is a first lens group,
the driven body is a first driven body,
the opening is a first opening,
the camera module further comprises a second driven body including a second lens group disposed on the second optical axis,
the housing includes a third housing section: housing the second driven body; having a third hollow space having a second opening that is open in the perpendicular direction; and disposed in another one of the parallel directions of the drive unit, and
the holder includes a third portion disposed in the third hollow space, holding the second driven body, and disposed in the other parallel direction of the second portion.

6. The camera module according to claim 1, wherein
the driven body includes a lens barrel holding the lens group, and
the first portion holds the lens barrel.

7. The camera module according to claim 1, wherein the first portion directly holds the lens group.

8. The camera module according to claim 7, further comprising a lens cover disposed opposite the first portion with the lens group being interposed between the lens cover and the first portion so as to surround the lens group in combination with the first portion.

9. The camera module according to claim 1, wherein
the second housing section includes a first wall, a second wall, and a third wall located away from the second optical axis in a first direction, a second direction, and a third direction respectively that are perpendicular to the second optical axis,
the second hollow space is delineated by the first wall, the second wall, and the third wall,
the opening is located away from the second optical axis in a fourth direction perpendicular to the second optical axis,
the drive unit includes a fourth wall, a fifth wall, a sixth wall, and a seventh wall located away from the second optical axis in the first direction, the second direction, the third direction, and the fourth direction respectively,
the hole is delineated by the fourth wall, the fifth wall, the sixth wall, and the seventh wall,
the second direction and the third direction are perpendicular to the first direction and are opposite each other, and
the first direction and the fourth direction are opposite each other.

10. The camera module according to claim 1, wherein the drive unit drives the second portion in a direction parallel to the second optical axis.

11. The camera module according to claim 10, wherein the drive unit drives the second portion in a direction perpendicular to the second optical axis.

12. The camera module according to claim 1, wherein the housing includes a support plate having: a first main face facing an intermediate direction between a direction perpendicular to the second optical axis and a direction parallel to the second optical axis from the reflecting element toward the lens group so as to support the reflecting element; and a second main face opposite the first main face and facing an empty space.

13. The camera module according to claim 1, further comprising a fixed lens group housed in the second hollow space, disposed between the reflecting element and the lens group, and fixed to the housing.

14. The camera module according to claim 1, wherein the lens group has an outer diameter larger than an outer diameter of the second portion.
